(19) United States
(12) Patent Application Publication
(10) Pub. No.: US 2024/0185043 A1
(43) Pub. Date: Jun. 6, 2024

(54) Generating Synthetic Heterogenous Time-Series Data

(71) Applicant: Google LLC, Mountain View, CA (US)

(72) Inventors: Jinsung Yoon, San Jose, CA (US); Michel Jonathan Mizrahi, Sanford, CA (US); Nahid Farhady Ghalaty, San Diego, CA (US); Thomas Dunn Henry Jarvinen, Methuen, MA (US); Ashwin Sura Ravi, Seattle, WA (US); Peter Robert Brune, Woodbury, MN (US); Fanyu Kong, Tampa, FL (US); David Roger Anderson, Lakeville, MN (US); George Lee, San Francisco, CA (US); Farhana Bandukwala, San Clemente, CA (US); Eliezer Yosef Kanal, Pittsburgh, PA (US); Sercan Omer Arik, San Francisco, CA (US); Tomas Pfister, Redwood City, CA (US)

(21) Appl. No.: 18/389,010

(22) Filed: Nov. 13, 2023

Related U.S. Application Data
(60) Provisional application No. 63/425,124, filed on Nov. 14, 2022.

(51) Int. Cl. G06N 3/0475; G06N 3/0455

(52) U.S. Cl. CPC G06N 3/0475; G06N 3/0455

(57) ABSTRACT

The present disclosure provides a generative modeling framework for generating highly realistic and privacy preserving synthetic records for heterogenous time-series data, such as electronic health record data, financial data, etc. The generative modeling framework is based on a two-stage model that includes sequential encoder-decoder networks and generative adversarial networks (GANs).

### CROSS-REFERENCE TO RELATED APPLICATIONS

The present application claims priority to U.S. Provisional Application No. 63/425,124, filed Nov. 14, 2022, the disclosure of which is hereby incorporated by reference herein.

### BACKGROUND

Electronic Health Records (EHR) provide tremendous potential for enhancing patient care, embedding performance measures in clinical practice, and facilitating clinical research. Statistical estimation and machine learning models trained on EHR data can be used to diagnose diseases, track patient wellness, and predict how patients respond to specific drugs.

To be able to develop such models, researchers and practitioners need access to the data. However, data privacy concerns and patient confidentiality regulations continue to pose a barrier to data access. Conventional methods to anonymize data are often tedious and costly, requiring a lot of processing power. Moreover, they can distort important features from the original dataset, decreasing the utility of the data significantly, and they are often susceptible to privacy attacks even when the de-identification process is in accordance with existing standards.

### SUMMARY

Synthetic data can open new horizons for data sharing. For synthetic data to be useful, the data should be high fidelity and should meet particular privacy measures. For high fidelity/utility, the synthesized data should be useful for the task of interest, giving similar downstream performance when a diagnostic model is trained on it. To meet privacy measures, the synthesized data should not reveal any real patient's identity.

The present disclosure provides a generative modeling framework for generating highly realistic and privacy preserving synthetic data. The generative modeling framework is based on a two-stage model that includes sequential encoder-decoder networks and generative adversarial networks (GANs). The generated synthetic data may include, for example, synthetic electronic health record data, synthetic financial data, or any of a variety of types of other types of confidential or sensitive data. The generative modeling framework is accurate and efficient, reducing processing power as compared to conventional data anonymization techniques while maintaining accurate data.

According to aspects of the disclosure, a method comprises receiving original input data; training an encoder-decoder model using the original input data, the encoder-decoder model comprising an encoder and a decoder, the training including encoding the original input data into latent representations; and training a generative adversarial network (GAN) framework, including a generator and a discriminator, based on the latent representations. The method may further include generating synthetic data using the trained generator and the trained decoder. Such generating may include sampling random vectors; generating synthetic embeddings; decoding the synthetic embeddings to synthetic data; decoding synthetic categorical embeddings; and renormalizing synthetic numerical data.

According to some examples, the original input data may include one or more of static numeric features, static categorical features, temporal numeric features, temporal categorical features, or measurement time. According to some examples, the original input data may include heterogenous time-series data

According to some examples, training the encoder-decoder model comprises generating missing patterns representing missing features of the original input data. Training the GAN framework may include generating original encoder states using the trained encoder, original input data, and the missing patterns. Training the encoder-decoder model may include stochastic normalization for numerical features. Training the encoder-decoder model may include transforming categorical data into one-hot encoded data; training a temporal categorical encoder and a temporal categorical decoder; transforming the one-hot encoded data into categorical embeddings.

According to some examples, the encoder-decoder model is trained using reconstruction loss, and the GAN framework is trained using adversarial loss. The reconstruction loss may use mean square error for temporal features, measurement time, and static features.

Another aspect of the disclosure provides a system for generating synthetic data. The system may include an encoder-decoder model comprising an encoder and a decoder; and a generative adversarial network (GAN), comprising a generator and a discriminator, wherein the GAN is trained using latent representations from a training of the encoder-decoder model. In generating the synthetic data, the generator may be configured to receive random sample vectors and generate synthetic representations, and the decoder is configured to decode the synthetic representations. In decoding the synthetic representations, the decoder may be configured to decode synthetic embeddings to synthetic data; decode synthetic categorical embeddings; and renormalize synthetic numerical data.

According to some examples, the encoder-decoder model may be trained using original input data, the training including encoding the original input data into the latent representations that are provided to the GAN. Training the encoder-decoder model may include generating missing patterns representing missing features of the original input data. Training the GAN framework comprises generating original encoder states using the trained encoder, original input data, and the missing patterns. The training of the encoder-decoder model may include transforming categorical data into one-hot encoded data; training a temporal categorical encoder and a temporal categorical decoder; and transforming the one-hot encoded data into categorical embeddings.

According to some examples, the original input data may include heterogenous time-series data.

According to some examples, the encoder-decoder model is trained using reconstruction loss, and the GAN framework is trained using adversarial loss.

Another aspect of the disclosure provides a non-transitory computer-readable medium storing instructions executable by one or more processors to perform a method comprising receiving original input data; training an encoder-decoder model using the original input data, the encoder-decoder model comprising an encoder and a decoder, the training including encoding the original input data into latent representations; and training a generative adversarial network (GAN) framework, including a generator and a discriminator, based on the latent representations.

### BRIEF DESCRIPTION OF DRAWINGS

FIG. 1 is a functional block diagram illustrating an overview of a synthetic data generation system according to aspects of the disclosure.

FIG. 2 is a block diagram illustrating an example architecture of the synthetic data generation system according to aspects of the disclosure.

FIG. 3 illustrates an example of converting raw data into multiple feature categories, according to aspects of the disclosure.

FIG. 4 is a block diagram illustrating an example of training a synthetic data generation system according to aspects of the disclosure.

FIG. 5 illustrates an example encoder-decoder architecture to convert categorical features into latent representations according to aspects of the disclosure.

FIG. 6 is a block diagram illustrating model inference of a synthetic data generation system according to aspects of the disclosure.

FIG. 7 is a block diagram illustrating an example of membership inference privacy metrics that may be used to evaluate privacy of generated synthetic datasets according to aspects of the disclosure.

FIG. 8 is a block diagram illustrating an example of re-identification privacy metrics that may be used to evaluate privacy of generated synthetic datasets according to aspects of the disclosure.

FIG. 9 is a block diagram illustrating an example of attribute inference privacy metrics that may be used to evaluate privacy of generated synthetic datasets according to aspects of the disclosure.

FIG. 10 is a flow diagram illustrating an example method according to aspects of the disclosure.

FIG. 11 is a block diagram illustrating an example computing environment according to aspects of the disclosure.

### DETAILED DESCRIPTION

The present disclosure provides a system and method for generating synthetic data that is accurate and reliable. Such synthetic data may be used in place of real data for machine learning or other artificial intelligence tasks, such as diagnoses, projections, forecasts, or the like. The system and method includes encoding and decoding features, normalizing complex distributions, conditioning adversarial training, and representing missing data. By using the synthetic data, privacy and confidentiality of subjects of the original data is protected.

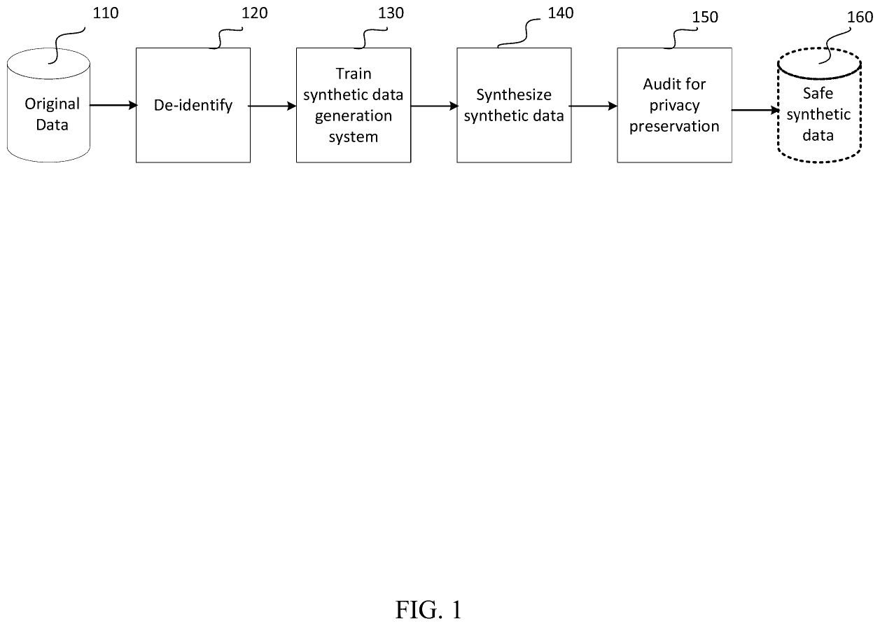

FIG. 1 is a functional block diagram illustrating an overview of a synthetic data generation system. The system receives original data 110 as input and generates synthetic data 160 that maintains relevant statistical properties of downstream tasks while preserving the privacy of the original data 110. The original data may be heterogenous, including time-varying and static features that are partially available.

In block 120, the original data 110 is de-identified, such that information that may be used to identify a subject of the original data is removed. Such information may include, for example, a person's name, address, picture, date of birth, social security number, phone number, account number, or any other identifiers.

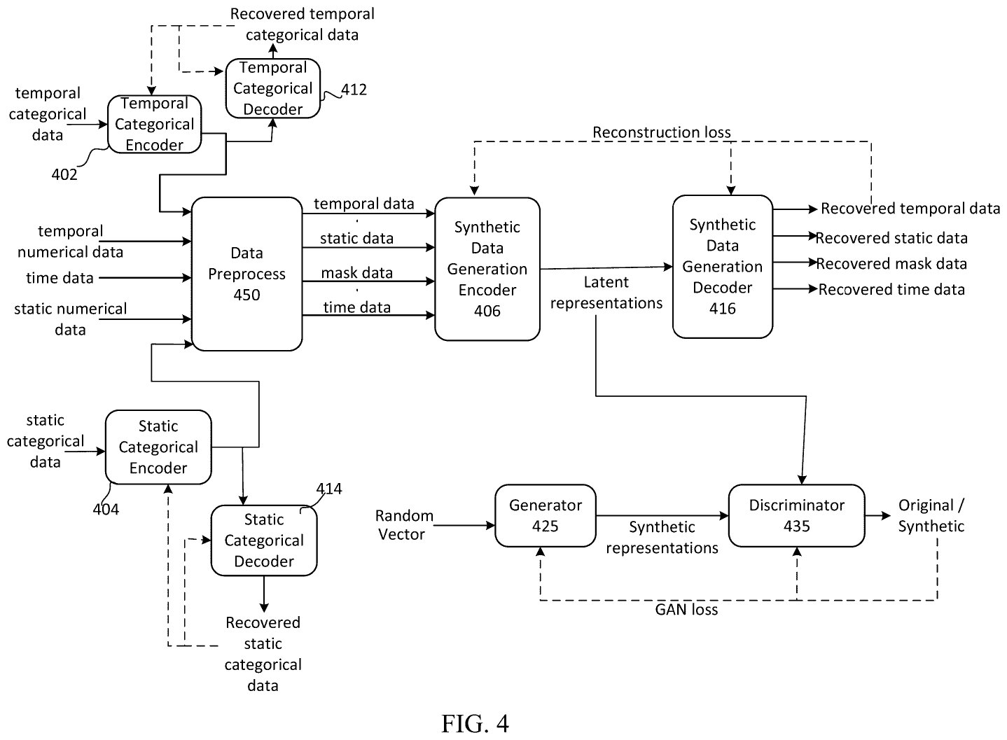

Block 130 includes training the synthetic data generation system. In such training, pairs of encoder-decoder models are trained based on reconstruction losses. Generator and discriminator models are trained by generative adversarial network (GAN) loss. Such training is described in further detail below in connection with FIG. 4.

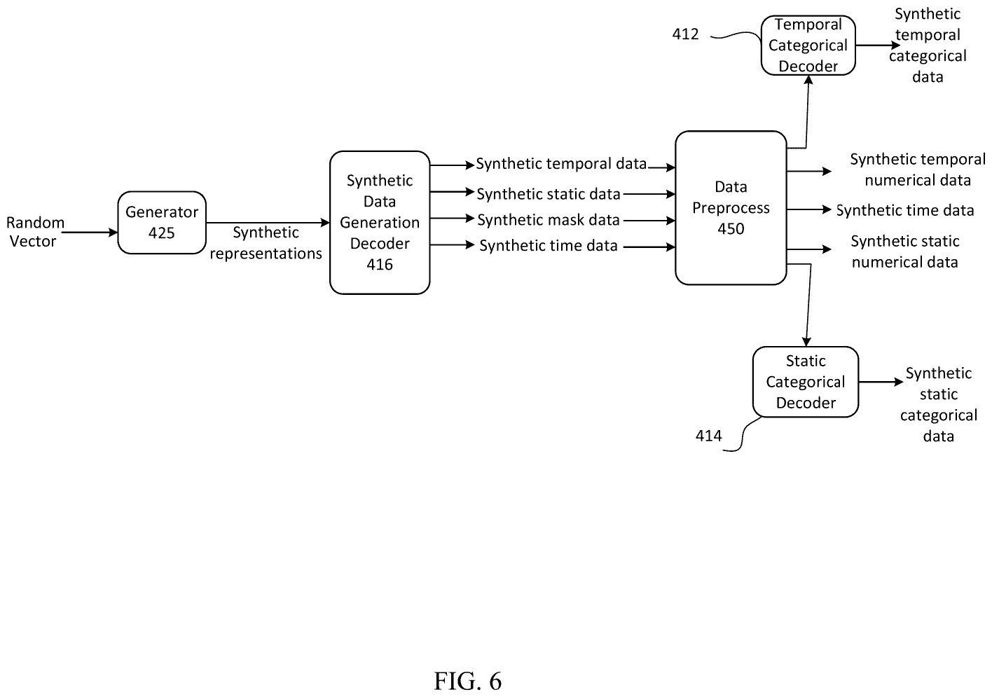

In block 140, synthetic data is generated. Generating the synthetic data includes converting random vectors into synthetic representations. One or more decoders convert the synthetic representations to synthetic data, such as temporal, static, and/or time data. Generating the synthetic data is described in further detail below in connection with FIG. 6.

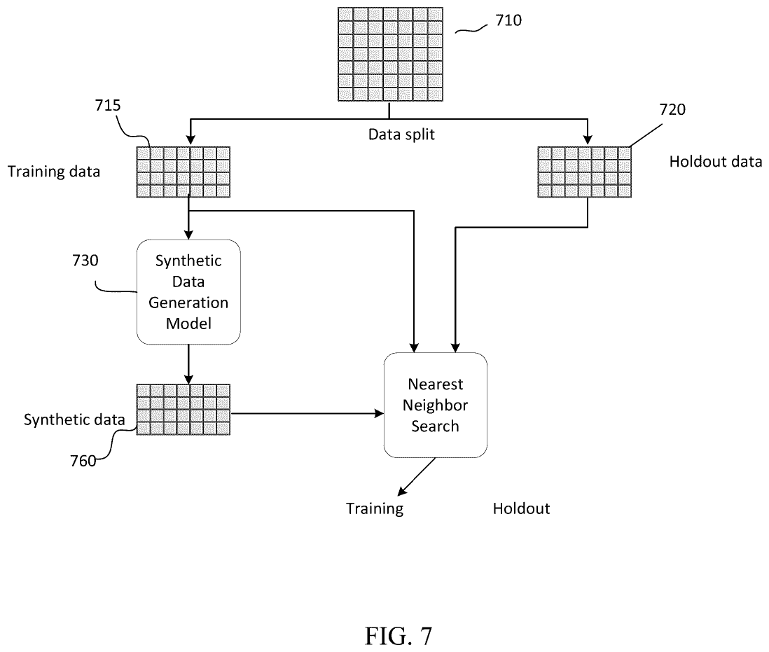

In block 150, the synthetic data is audited for privacy preservation. For example, various privacy metrics may be used to evaluate the privacy of generated synthetic datasets. Examples of such metrics are described in further detail in connection with FIGS. 7-9. The synthetic data 160 that results from this process is determined to be safe in that it does not risk revealing privacy information.

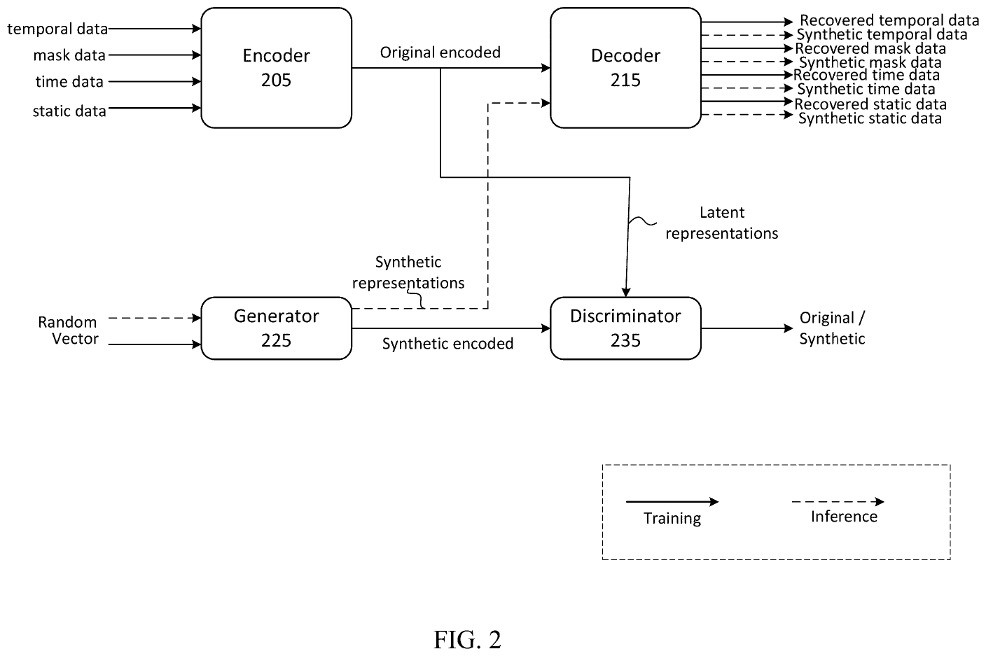

FIG. 2 is a block diagram illustrating an example architecture of the synthetic data generation system. The system uses a sequential encoder-decoder architecture, including encoder 205 and decoder 215, in conjunction with a GAN architecture, including generator 225 and discriminator 235.

The encoder-decoder architecture learns mapping from original data to low-dimensional representations, and vice versa. While learning the mapping, esoteric distributions of various numerical and categorical features may pose a challenge. For example, some values or numerical ranges might be much more common, dominating a distribution, but the system should be capable of modeling rare cases or situations. To handle such data, raw data may be converted to distributions. The distributions may be used for more stable and accurate training of the encoder-decoder model and GAN. Mapped low-dimensional representations, generated by the encoder, are used for GAN training. The low dimensional representations are generated and then converted to raw synthetic data with the decoder 215.

Encoder 205 receives training data, such as temporal data, mask data, time data, and static data. The training data may include original input data, such as actual records that have been de-identified. The encoder 205 may include a plurality of encoders, such as a static categorial encoder, a temporal categorical encoder, a one-hot encoder, etc. The encoder 205 jointly extracts representations from the multiple types of data. Heterogeneous features are encoded into joint representations. During training, latent representations are provided from the encoder 205 to the discriminator 235. During inference, synthetic representations are provided from the generator 225 to the decoder 215.

Decoder 215 decodes the joint representations and generates synthetic data samples. The generated synthetic data samples may correspond to the input training data. In this example, the generated synthetic data includes synthetic temporal data, synthetic mask data, synthetic time data, and synthetic static data.

In addition to outputting synthetic data, the decoder 215 outputs recovered data. The recovered data may be used to determine whether enough of the original input data has been retained to obtain an accurate prediction result during inference. By way of example, the recovered data may be compared with the original input data, or predictions may be generated with the recovered data and with the original input data and such predictions may be compared.

A random vector is input to generator 225, which generates synthetic encoded data provided to the discriminator 235 during training. The random vector may be, for example, a vector of random numbers drawn from a normal distribution. The discriminator 235 output original and synthetic data, which may be used to train the GAN framework, such as through adversarial loss. During inference, the generator 225 outputs synthetic representations to the decoder 215 of the encoder-decoder model, for decoding the synthetic representations into synthetic data output.

During training, the encoder 205 and decoder 215 are trained based on reconstruction losses. Generator 225 and discriminator 235 are trained by GAN loss.

In training the encoder-decoder model, for differential privacy, training is modified by randomly perturbing the models. For example, deep learning with differential privacy may be implemented. For instance, Differentially-Private Stochastic Gradient Descent (DP-SGD) can be used to train the encoder-decoder and GAN models to achieve a differentially private generator and decoder with respect to the original data. Since synthetic data are generated through the differentially private generator and decoder using the random vector as the inputs, the generated synthetic data are also differentially private with respect to the original data.

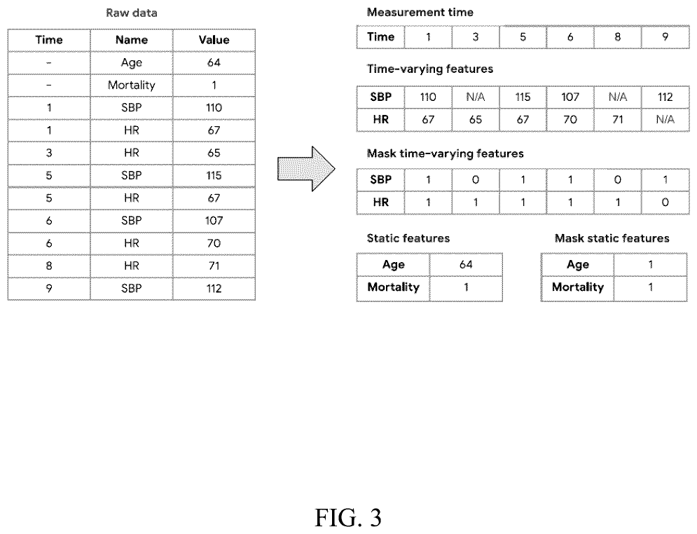

Electronic record data often consists of both static and time-varying features. Each static and temporal feature can be further categorized into either numeric or categorical. FIG. 3 illustrates an example of converting raw data into multiple feature categories. In this example, the feature categories include measurement time, time-varying features, mask features, and static features. While four categories of features are illustrated in this example, it should be understood that any number of categories of features may be included in the conversion. Moreover, the types of feature categories can be varied.

Categories of features may depend on a type of data captured in the electronic record. For example, for electronic health records, categories of features for a patient index i may include: (1) measurement time as u, (2) static numeric feature (e.g., age) as sⁿ, (3) static categorical feature (e.g., marital status) as s^{c}, (4) time-varying numerical feature (e.g., vital signs) as tⁿ, (5) time-varying categorical feature (e.g., heart rhythm) as t^{c}. The sequence length of time-varying features is denoted as T(i). Note that each patient record may have a different sequence length. With all these features, given training data can be represented as:

D={sⁿ(i),s^{c}(i,{u_{τ}(i),t_{τ}ⁿ(i),t_{τ}^{c}(i)}_{τ=1}^{T(i)}}ᵢ₌₁^{N},

where N is the total number of patient records.

In some examples, datasets may contain missing features. In the example of electronic health records, patients might visit clinics sporadically, or measurements or information may not be completely collected at each visit. As shown in FIG. 3, some values of time-varying features may be missing, as denoted by “N/A”. In the mask features, missing values may be represented by “0” while observed values are represented by “1.” In order to generate realistic synthetic data, missingness patterns should also be generated in a realistic way. A binary mask m may use 1/0 values based on whether a feature is observed (m=1) or not (m=0). The missingness for the features for the training data may be represented as:

D_{M}={mⁿ(i),m^{c}(i),{m_{τ}ⁿ(i),m_{τ}^{c}(i)}_{τ=1}^{T(i)}}ᵢ₌₁^{N}.

There is no missingness for measurement time. It may be assumed that time is always given whenever at least one time-varying feature is observed.

FIG. 4 illustrates an example of training the synthetic data generation system. As generally shown in this figure, three pairs of encoder-decoder models are trained based on reconstruction losses, and the generator and discriminator models are trained by GAN loss. The pairs of encoder-decoder models in this example include temporal categorical encoder 402 and temporal categorical decoder 412, static categorical encoder 404 and static categorical decoder 414, and synthetic data generation encoder 406 and synthetic data generation decoder 416. In other examples, different encoder-decoder model pairs may be present. The GAN model includes generator and discriminator architectures based on multi-layer perceptron (MLP).

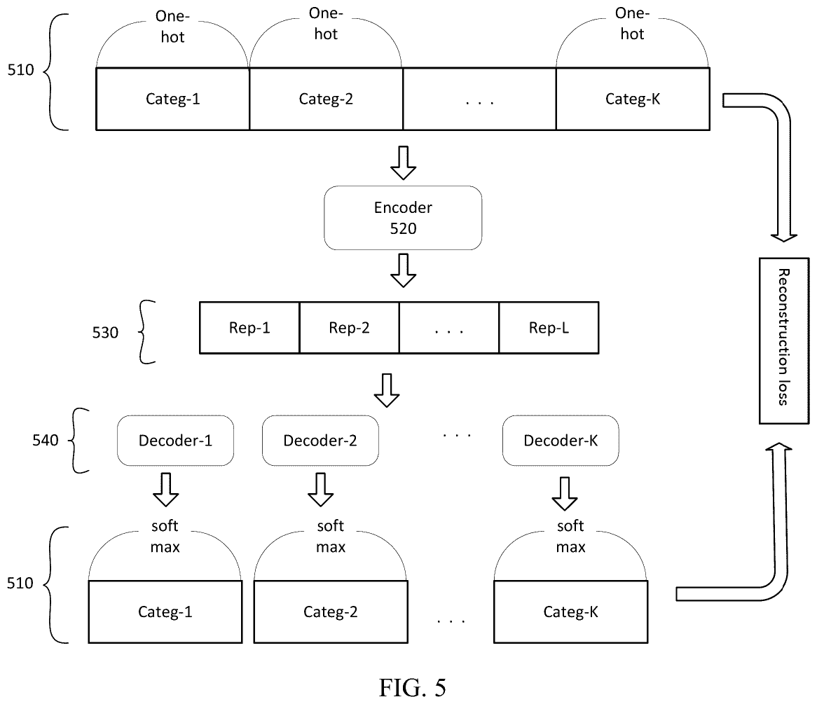

Handling categorical features poses a unique challenge beyond numerical features, as meaningful discrete mappings need to be learned. FIG. 5 illustrates an example of encoding and decoding categorical features, such as performed by the temporal categorical encoder 412 and decoder 412 and the static categorical encoder 414 and decoder 414 (FIG. 4). As shown in FIG. 5, one-hot encoding is one possible solution. By encoding and decoding categorical features to obtain learnable mappings, such learnable mappings may be used for generative modeling.

Categorical features (s^{c}) are encoded into one-hot encoded features (s^{co}) 510. The categorical features may be static categorical features or temporal categorical features.

A categorical encoder (CE^{s}) 520 may be used to transform the one-hot encoded features 510 into the latent representations (s^{ce}) 530:

s^{ce}=CE^{s}[s^{co}]=CE[s₁^{co}, . . . , s_{K}^{co}],

where K is the number of categorical features. Multi-head decoders ([CF₁^{s}; . . . , CF_{K}^{s}]) 540 may be used to recover the original one-hot encoded data 510 from the latent representations 530:

ŝₖ^{co}=CFₖ^{s}[s^{ce}]

Both encoder (CE^{s}) 520 and multi-head decoders ([CF₁^{s}; . . . , CF_{K}^{s}]) 540 may be trained with softmax cross entropy objective (L_{c}):

$${min}_{{CE}^{s} , {CF}_{1}^{s} , … , {CF}_{K}^{s}} {\sum }_{k = 1}^{K} {L}_{c} ( {CF}_{i}^{s} [ CE [ {s}_{1}^{co} , … , {s}_{K}^{co} ] ] , {s}_{i}^{co} ) .$$

Separate encoder-decoder models may be used for static and temporal categorical features. The transformed representations may be denoted as s^{ce} and t^{ce}, respectively.

Returning to FIG. 4, the encoder-decoder models may each be trained using reconstruction loss. The reconstruction loss may measure how well the recovered data corresponds to the input data. For example, for the temporal categorical encoder-decoder model, the reconstruction loss may measure how well the recovered temporal categorical data corresponds to the input temporal categorical data. For the static categorical encoder-decoder model, the reconstruction loss may measure how well the recovered static categorical data from the static categorical decoder 414 corresponds to the input static categorical data. For the synthetic data generation encoder-decoder model, the reconstruction loss may account for the temporal data, static data, mask data, and time data.

Data preprocessing unit 450 receives training data, such as numerical data and categorical data. As shown, the numerical data includes temporal numerical data, time data, and static numerical data. The categorical data may be received from encoder-decoder pairs. For example, as shown, temporal categorical data is received at the data preprocessing unit 450 from the temporal categorical encoder 402, and static categorical data is received from the static categorical encoder 404. The data preprocessing unit 450 outputs the preprocessed data to the synthetic data generation encoder 406. Such preprocessed data may include temporal data, static data, mask data, and time data. The synthetic data generation encoder 406 condenses such data into latent representations. The synthetic data generation decoder 416 inputs these encoded representations (e) and aims to recover the original static, temporal, measurement time, and mask data. If the synthetic data generation decoder 416 can recover the original heterogeneous data correctly, it can be inferred that the set of encoder states e contains most of the information in the original heterogeneous data.

The latent representations are also used for training the GAN model, so that the trained generative model can generate realistic encoded representations that can be decoded into realistic raw data. For example, the latent representations are provided to the discriminator 435, which also receives synthetic representations from the generator 425. The discriminator 435 outputs original and synthetic data. GAN loss from such output is used to train the generator 425 and discriminator 435.

High-dimensional sparse data is challenging to model with GANs, as it might cause convergence stability and mode collapse issues, and the GANs might be less data efficient. Using an encoder-decoder model is beneficial as it condenses high-dimensional heterogeneous features into latent representations that are low dimensional and compact. The encoder model (F) inputs the static data (sⁿ, s^{ce}), temporal data (tⁿ, t^{ce}), time data (u), and mask data (mⁿ,m^{c},m_{τ}ⁿ,m_{τ}^{c}) and generates the encoder states (e):

e=E(sⁿ,s^{ce},tⁿ,t^{ce},u,mⁿ,m^{c},m_{τ}ⁿ,m_{τ}^{c})

The synthetic data generation decoder 416 inputs these encoded representations (e) and aims to recover the original static, temporal, measurement time, and mask data.

ŝⁿ,ŝ^{ce},\hat{t}ⁿ,\hat{t}^{ce},û,\hat{m}ⁿ,\hat{m}^{c},\hat{m}_{τ}ⁿ,\hat{m}_{τ}^{c}=F(e)

If the synthetic data generation decoder 416 can recover the original heterogeneous data correctly, it can be inferred that the set of encoder states e contains most of the information in the original heterogeneous data.

For temporal, measurement time, and static features, mean square error (Lm) may be used as the reconstruction loss. Errors are only computed when the features are observed. For the mask features, binary cross entropy (Lc) may be used as the reconstruction loss because the mask features consist of binary variables. Thus, the full reconstruction loss becomes:

min L_{c}(\hat{m}ⁿ,mⁿ)+L_{c}(\hat{m}^{c},m^{c})+L_{c}(\hat{m}_{τ}ⁿ,m_{τ}ⁿ)+L_{c}(\hat{m}_{τ}^{c},m_{τ}^{c})+λ[Lₘ(û,u)+Lₘ(mⁿŝⁿ,mⁿsⁿ)+Lₘ(m^{c}ŝ^{ce},m^{c}s^{ce})+Lₘ(m_{τ}ⁿ\hat{t}^{t},m_{τ}ⁿtⁿ)+Lₘ(m_{τ}^{c}\hat{t}^{ce},m_{τ}^{c}t^{ce})],

where λ is the hyper-parameter to balance the cross entropy loss and mean squared loss.

The trained encoder model is used to map raw data into encoded representations, that are then used for GAN training so that the trained generative model can generate realistic encoded representations that can be decoded into realistic raw data.

Trained encoder 406 generates original encoder states (e) using the original raw data. The original dataset gets converted into Dₑ={e(i)}ᵢ₌₁^{N}. The generative adversarial network (GAN) training framework, including generator 425 and discriminator 435, is used to generate synthetic encoder states ê to make synthetic encoder states dataset \hat{D}ₑ. More specifically, the generator (G) 425 uses the random vector (z) to generate synthetic encoder states as follows.

ê=G(z)

The discriminator (D) 435 tries to distinguish the original encoder states e from the synthetic encoder states ê. The GAN framework may be a Wasserstein GAN with Gradient Penalty (WGAN-GP) due to its training stability for heterogeneous data types, or another type of GAN framework. The optimization problem can be stated as:

$${max}_{G} {min}_{D} \frac{1}{N} {\sum }_{j = 1}^{N} D ( e [ i ] ) - \frac{1}{N} {\sum }_{i = 1}^{N} D ( \hat{e} [ i ] ) + η [ {( ‖ ∇ D ( \tilde{e} [ i ] ) ‖ - 1 )}^{2} ] \\ where \tilde{e} [ i ] = ℯe [ i ] + ( 1 - e ) \tilde{e} [ i ] and ℯ \sim U [ 0 , 1 ] ,$$

where η is WGAN-GP hyper-parameter, which is set to 10.

According to some examples, a normalization and renormalization procedure may be performed to prevent mode collapse resulting from cumulative distribution functions that are discontinuous or have significant jumps in values of observations. The procedure may be a stochastic normalization/renormalization procedure. The normalization and renormalization procedures map raw feature distributions to and from a more uniform distribution that is easier to model with GANs. As an example, the normalization/renormalization procedure may include estimating the ratio of each unique value in the original feature; transforming each unique value into the normalized feature space with the ratio as the width; and mapping 1 into [0, 0.1] range in a uniformly random way. Stochastic normalization procedure may be represented as:
Input: Original feature X
1: Uniq(X)=Unique values of X, N=Length of (X)
2: lower-bound=0.0, upper-bound=0.0, \hat{X}=X
3: for val in Uniq(X) do
4: Find index of X whose value=val as idx(val)
5: Compute the frequency (ratio) of val as ratio(val)=Length of idx(val)/N
6: upper-bound=lower-bound+ratio(val)
7: \hat{X}[idx(val)]˜Uniform(lower-bound, upper-bound)
8: params[val]=[lower-bound, upper-bound]
9: lower-bound=upper-bound
10: end for
Output: Normalized feature (\hat{X}), normalization parameters (params)

Stochastic renormalization procedure may be represented as:
Input: Normalized feature (\hat{X}), normalization parameters (params)
1: X=\hat{X}
2: for param in params.keys do
3: Find index of \hat{X} whose value is in [param.values] as idx(param)
4: X[idx(param)]=param
5: end for
Output: Original feature X

The stochastic normalization can be highly effective in transforming features with discontinuous cumulative distribution functions into approximately uniform distributions while allowing for perfect renormalization into the original feature space. It is also highly effective for handling skewed distributions that might correspond to features with outliers. Stochastic normalization maps the original feature space (with outliers) into a normalized feature space (with uniform distribution), and then the applied renormalization recreates the skewed distributions with outliers.

In summary, training of the synthetic data generation system, described above, may be represented by the following pseudocode:

[symbol]

| | Input: original data D, where: D = {sⁿ(i), s^{c}(i), { [symbol] (i), [symbol] (i), [symbol] (i)} [symbol] }ᵢ₌₁^{N} | |
|---|---|---|
| | 1: | Generate missing patterns of D: D_{M} = {mⁿ(i), m^{c}(i), {m_{τ}ⁿ(i), m_{τ}^{c}(i)}_{τ = 1}^{T(i)}}_{i = 1}^{N} |
| | 2: | Transform categorical data (s^{c}, t^{c}) into one-hot encoded data (s^{co} , t^{co}) |
| | 3: | Train static categorical encoder and decoder: |
| | | $\text{?} {\sum }_{k = 1}^{K} {L}_{c} ( {CF}_{i}^{s} [ CE [ {s}_{1}^{co} , … , {s}_{K}^{co} ] ] , {s}_{i}^{co} )$ |
| | 4: | Train temporal categorical encoder and decoder: |
| | | $\text{?} {\sum }_{k = 1}^{K} {L}_{c} ( {CF}_{i}^{t} [ CE [ {t}_{1}^{co} , … , {t}_{K}^{co} ] ] , {t}_{i}^{co} )$ |
| | 5: | Transform one-hot encoded data (s^{co} , t^{co}) to categorial embeddings (s^{ce} , t^{ce}) |
| | 6: | Stochastic normalization for numerical features (sⁿ, tⁿ, u) |
| | 7: | Train encoder-decoder model using: |
| | | min L_{c}( [symbol] , [symbol] ) + L_{c}( [symbol] , [symbol] ) + L_{c}( [symbol] , [symbol] ) + L_{c}( [symbol] , [symbol] ) + |
| | | λ\|Lₘ(û, u) + Lₘ( [symbol] , [symbol] ) + Lₘ( [symbol] , [symbol] ) + Lₘ( [symbol] , [symbol] ) + Lₘ( [symbol] , [symbol] )\|, |
| | 8: | Generate original encoder states e using trained encoder (E), original data D, and |
| | | missing patterns D_{M} |
| | 9: | Train generator (G) and discriminator D using GAN: |
| | | ${max}_{G} {min}_{D} \frac{1}{N} {\sum }_{i = 1}^{N} D ( e [ i ] ) - \frac{1}{N} {\sum }_{i = 1}^{N} D ( \hat{e} [ i ] ) + η [ {( ‖ ∇ D ( \hat{e} [ i ] ) ‖ - 1 )}^{2} ]$ |
| | Output: Trained generator (G), trained decoder (F), trained categorical decoder (CF^{s}, | |
| CF^{t}) | | |

[symbol]

indicates data missing or illegible when filed

FIG. 6 illustrates an inference process of the synthetic data generation system. After training both the encoder-decoder and GAN models, synthetic heterogeneous data can be generated from any random vector. In some examples, the inference process may utilize only the trained generator 425 and decoder 416. As shown in FIG. 6, the trained generator 425 uses the random vector to generate synthetic encoder states, or synthetic representations:

ê=G(z) where z˜N(0,l)

The trained decoder (F) 416 uses the synthetic encoder states as the inputs to generate synthetic temporal, static, time, and mask data. Synthetic temporal data is represented as (\hat{t}ⁿ,\hat{t}^{ce}), synthetic static data is represented as (ŝⁿ,ŝ^{ce}); synthetic time data is represented as (û); and synthetic mask data is represented as (mⁿ,m^{c},m_{τ}ⁿ,m_{τ}^{c}).

ŝⁿ,ŝ^{ce},\hat{t}ⁿ,\hat{t}^{ce},û,\hat{m}ⁿ,\hat{m}^{c},\hat{m}_{τ}ⁿ,\hat{m}_{τ}^{c}=F(ê)

Representations for the static and temporal categorical features are decoded using the decoders 412, 414 to generate synthetic static categorical (ŝ^{c}) data and temporal categorical (\hat{t}^{c}) data. The decoders 412, 414 may correspond to the decoders 412, 414 of FIG. 4 and the decoders 540 of FIG. 5.

ŝ^{c}=CF^{s}(ŝ^{ce}),\hat{t}^{c}=CF^{t}(\hat{t}^{ce})

The generated synthetic data are represented as:

\hat{D}={ŝⁿ(i),ŝ^{c}(i),{û_{τ}(i),\hat{t}_{τ}ⁿ(i),\hat{t}_{τ}^{c}(i)}_{τ=1}^{\hat{T}(i)}}ᵢ₌₁^{M}

\hat{D}_{M}={\hat{m}ⁿ(i),\hat{m}^{c}(i),{\hat{m}_{τ}ⁿ(i),\hat{m}_{τ}^{c}(i)}_{τ=1}^{\hat{T}(i)}}ᵢ₌₁^{M}

With trained models, an arbitrary number of synthetic data samples can be generated. The arbitrary number can be greater than the original data.

In summary, inference of the synthetic data generation system can be represented by the following pseudocode:
Input: Trained generator (G), trained decoder (F), the number of synthetic data (M), trained categorical decoder (CF^{s}, CF^{t})
1: Sample M random vectors z˜N(0, 1)
2. Generate synthetic embeddings: ê=G(z)
3: Decode synthetic embeddings to synthetic data:

ŝⁿ,ŝ^{ce},\hat{t}ⁿ,\hat{t}^{ce},û,\hat{m}ⁿ,\hat{m}^{c},\hat{m}_{τ}ⁿ,\hat{m}_{τ}^{c}=F(ê)
4: Decode synthetic categorical embeddings: ŝ^{c}=CF^{s}(ŝ^{ce}), (\hat{t}^{c})=CF^{t}(\hat{t}^{ce})
5: Renormalize synthetic numerical data (ŝ^{n,}\hat{t}ⁿ,û)
Output: Synthetic data \hat{D}={ŝⁿ(i),ŝ^{c}(i),{û_{τ}(i),\hat{t}_{τ}ⁿ(i),\hat{t}_{τ}^{c}(i)}_{τ=1}^{\hat{T}(i)}}ᵢ₌₁^{M} and synthetic missing pattern data \hat{D}_{M}={\hat{m}ⁿ(i),\hat{m}^{c}(i),{\hat{m}_{τ}ⁿ(i),\hat{m}_{τ}^{c}(i)}_{τ=1}^{\hat{T}(i)}}ᵢ₌₁^{M}

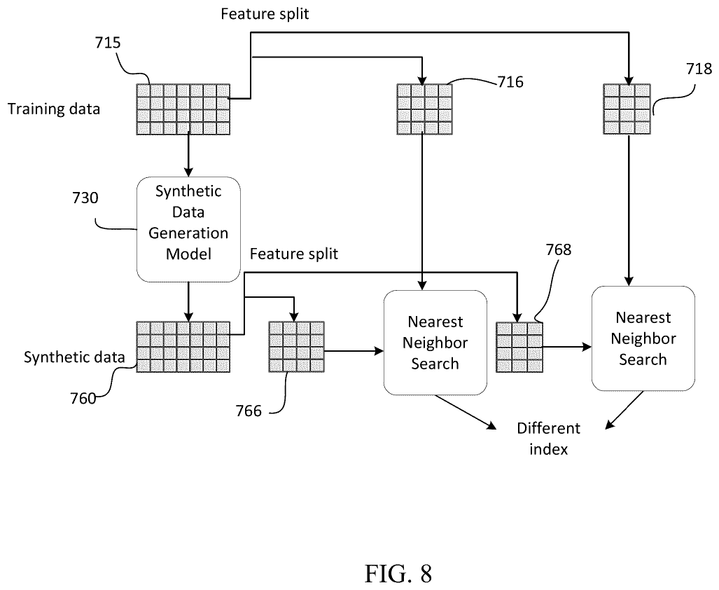

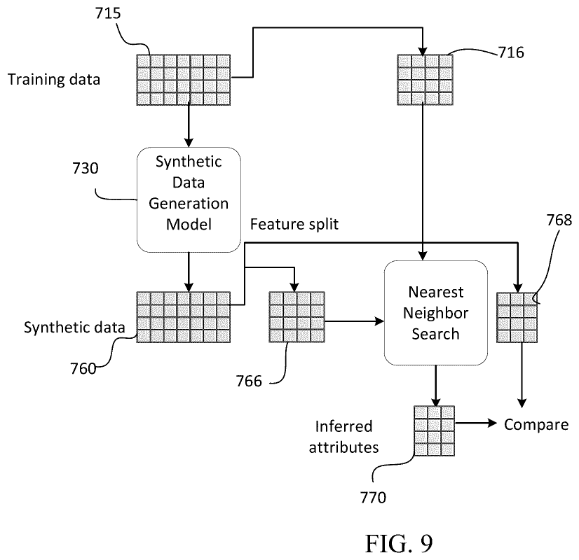

According to some examples, privacy metrics may be used to evaluate privacy of generated synthetic datasets. FIGS. 7-9 provide examples of such metrics, wherein FIG. 7 utilizes membership inference, FIG. 8 utilizes re-identification, and FIG. 9 utilizes attribute inference. In some examples, each of these metrics may be used to evaluate privacy, such as in audit phase 150 of FIG. 1. In other examples, one or some combination of these or other metrics may be used.

As shown in FIG. 7, original data 710 is split into training data 715 and holdout data 720. The training data 715 is input to the synthetic data generation model 730, which the holdout data 720 remains unprocessed. Synthetic data generation model 730 generates synthetic data 760 using the training data 715. The training data 715, holdout data 720 and synthetic data 760 are input to a nearest neighbor search, to explore a probability of data being a member of the training data 715 used for training the model 730.

In FIG. 8, the training data 715 is split into subsets 716, 718. The training data 715 is also used for training the synthetic data generation model 730, which generates synthetic data 760. The generated synthetic data 760 is also split into subsets 766, 768. While first training data subset 716 and first synthetic data subset 766 are input to a first nearest neighbor search, second training data subset 718 and second synthetic data subset 768 are input to second nearest neighbor search. The results of the nearest neighbor searches are compared to determine a probability whether some features can be reidentified by matching synthetic data to training data.

The example of FIG. 9 is similar to the example of FIG. 8 in that the training data 715 is split into a subset 716, and synthetic data 760 is split into subsets 766, 768. In this example, the nearest neighbor search predicts a value of sensitive data using the synthetic data, thereby generating inferred attributes data 770. The inferred attributes data 770 may be compared with the subset 768 to determine whether the sensitive data was accurately predicted.

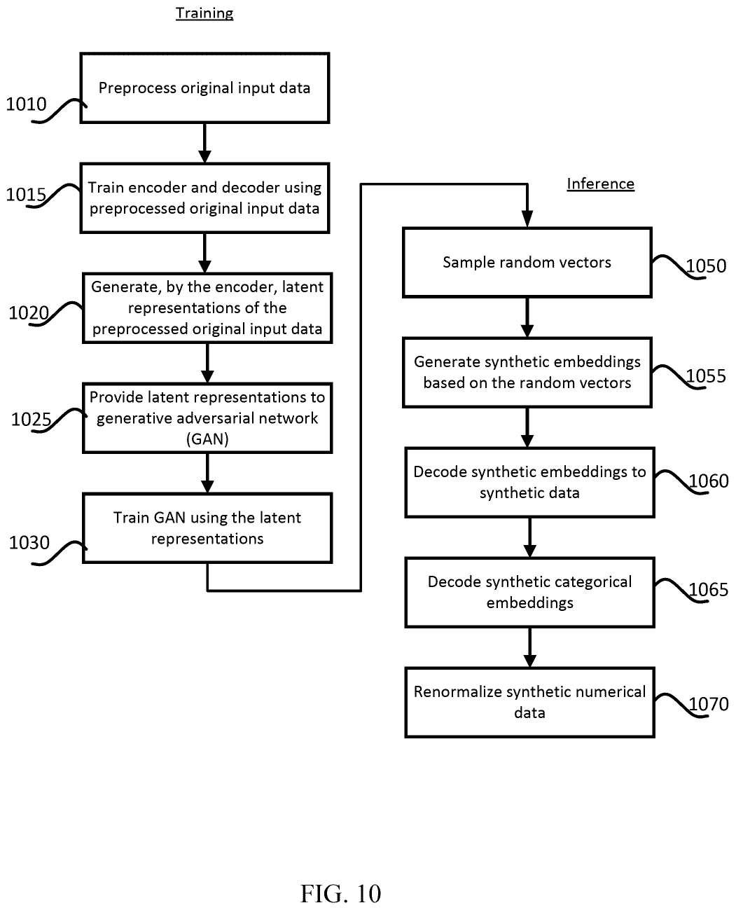

FIG. 10 is a flow diagram illustrating example methods of training a synthetic data generation system and generating synthetic data using the synthetic data generation system. The method may be performed by components of the system described above, including an encoder-decoder model in conjunction with a GAN framework. While the methods are described in a particular order, it should understand that an order of operations may be modified and some operations may be performed in parallel. Moreover, operations may be added or omitted.

In block 1010, original input data is received and pre-processed. The original input data may include heterogenous data from actual records, such as health records, financial records, or other types of documentation. Such pre-processing may include, for example, generating missing patterns, preparing categorical data, etc. Preparing the categorical data may include, for example, transforming the categorical data into one-hot encoded data, training a static categorical encoder and decoder, training a temporal categorical encoder and decoder, and transforming the one-hot encoded data to categorical embeddings. In some examples, pre-processing the data may further include stochastic normalization for numerical features.

In block 1015 a synthetic data generation encoder and decoder are trained using the preprocessed original input data. Such training may be performed by reconstruction loss, or any of a number of other techniques.

In block 1020, the encoder generates latent representations of the original input data. Such latent representations may include original encoder states, such as static data, temporal data, mask data, time data, etc. The latent representations may be generated using the original input data and missing patterns generated in block 1010. The latent representations are provided to the generative adversarial network (GAN) in block 1025, and specifically to a discriminator of the GAN.

The GAN includes a generator and the discriminator. In block 1030, the generator and discriminator are trained using the latent representations. Training may include adversarial loss or other techniques.

Blocks 1050-1070 describe an inference method using the system trained in blocks 1010-1030. During inference, in block 1050, the generator of the GAN samples random vectors, and generates synthetic embeddings based on the random vectors in block 1055.

In block 1060, the decoder of the encoder-decoder model decodes the synthetic embeddings to synthetic data, and in block 1065 it decodes synthetic categorical embeddings. In block 1070, the decoder renormalizes synthetic numerical data. The resulting output includes synthetic data. In some examples, the resulting output may further include synthetic missing patterns.

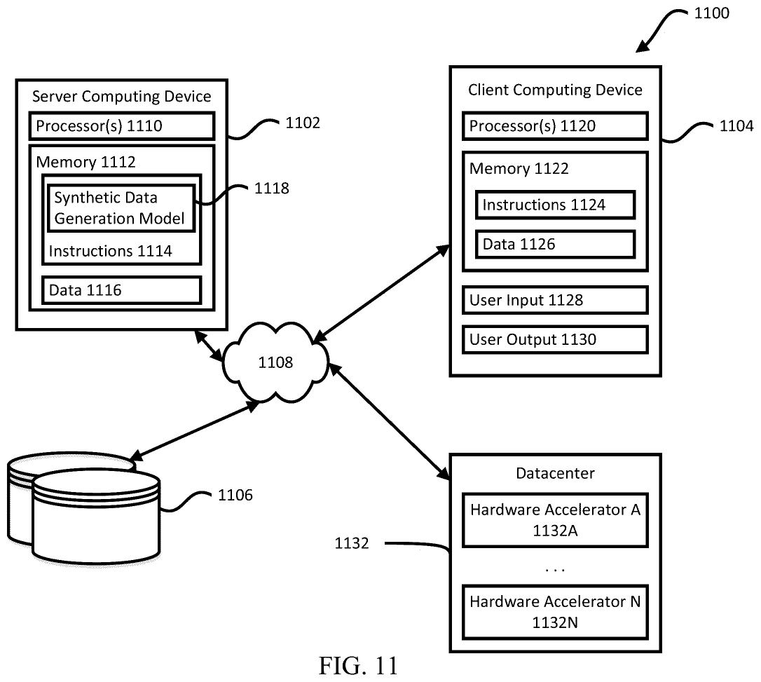

FIG. 11 is a block diagram illustrating an example computing environment 1100 for implementing training multivariate time series models using linear regression and ARIMA, and forecasting using such models. The system 1100 can be implemented on one or more devices having one or more processors in one or more locations, such as in server computing device 1102. Client computing device 1104 and the server computing device 1102 can be communicatively coupled to one or more storage devices 1106 over a network 1108. The storage devices 1106 can be a combination of volatile and non-volatile memory and can be at the same or different physical locations than the computing devices 1102, 1104. For example, the storage devices 1106 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 1102 can include one or more processors 1110 and memory 1112. The memory 1112 can store information accessible by the processors 1110, including instructions 1114 that can be executed by the processors 1110. The memory 1112 can also include data 1116 that can be retrieved, manipulated, or stored by the processors 1110. The memory 1112 can be a type of non-transitory computer readable medium capable of storing information accessible by the processors 1110, such as volatile and non-volatile memory. The processors 1110 can include one or more central processing units (CPUs), graphic processing units (GPUs), field-programmable gate arrays (FPGAs), and/or application-specific integrated circuits (ASICs), such as tensor processing units (TPUs).

The instructions 1114 can include one or more instructions that when executed by the processors 1110, causes the one or more processors to perform actions defined by the instructions. The instructions 1114 can be stored in object code format for direct processing by the processors 1110, or in other formats including interpretable scripts or collections of independent source code modules that are interpreted on demand or compiled in advance. The instructions 1114 can include instructions for implementing a synthetic data generation model 1118. The synthetic data generation model 1118 can be executed using the processors 1110, and/or using other processors remotely located from the server computing device 1102.

The data 1116 can be retrieved, stored, or modified by the processors 1110 in accordance with the instructions 1114. The data 1116 can be stored in computer registers, in a relational or non-relational database as a table having a plurality of different fields and records, or as JSON, YAML, proto, or XML documents. The data 1116 can also be formatted in a computer-readable format such as, but not limited to, binary values, ASCII or Unicode. Moreover, the data 1116 can include information sufficient to identify relevant information, such as numbers, descriptive text, proprietary codes, pointers, references to data stored in other memories, including other network locations, or information that is used by a function to calculate relevant data.

The client computing device 1104 can also be configured similarly to the server computing device 1102, with one or more processors 1120, memory 1122, instructions 1124, and data 1126. The client computing device 1104 can also include a user input 1128, and a user output 430. The user input 1128 can include any appropriate mechanism or technique for receiving input from a user, such as keyboard, mouse, mechanical actuators, soft actuators, touchscreens, microphones, and sensors.

The server computing device 1102 can be configured to transmit data to the client computing device 1104, and the client computing device 1104 can be configured to display at least a portion of the received data on a display implemented as part of the user output 430. The user output 430 can also be used for displaying an interface between the client computing device 1104 and the server computing device 1102. The user output 430 can alternatively or additionally include one or more speakers, transducers or other audio outputs, a haptic interface or other tactile feedback that provides non-visual and non-audible information to the platform user of the client computing device 1104.

Although FIG. 11 illustrates the processors 1110, 1120 and the memories 1112, 1122 as being within the computing devices 1102, 1104, components described herein can include multiple processors and memories that can operate in different physical locations and not within the same computing device. For example, some of the instructions 1114, 1124 and the data 1116, 1126 can be stored on a removable SD card and others within a read-only computer chip. Some or all of the instructions and data can be stored in a location physically remote from, yet still accessible by, the processors 1110, 1120. Similarly, the processors 1110, 1120 can include a collection of processors that can perform concurrent and/or sequential operation. The computing devices 1102, 1104 can each include one or more internal clocks providing timing information, which can be used for time measurement for operations and programs run by the computing devices 1102, 1104.

The server computing device 1102 can be connected over the network 1108 to a datacenter 1132 housing hardware accelerators 1132A-N. The datacenter 1132 can be one of multiple datacenters or other facilities in which various types of computing devices, such as hardware accelerators, are located. The computing resources housed in the datacenter 1132 can be specified for deploying forecast models, as described herein.

The server computing device 1102 can be configured to receive requests to process data 1126 from the client computing device 1104 on computing resources in the datacenter 432. For example, the environment 1100 can be part of a computing platform configured to provide a variety of services to users, through various user interfaces and/or APIs exposing the platform services. One or more services can be a machine learning framework or a set of tools for generating and/or utilizing forecasting neural networks or other machine learning forecasting models and distributing forecast results according to a target evaluation metric and/or training data. The client computing device 1104 can receive and transmit data specifying the target evaluation metrics to be allocated for executing a forecasting model trained to perform demand forecasting. The forecast system 1118 can receive the data specifying the target evaluation metric and/or the training data, and in response generate one or more forecasting models and distribute result of the forecast models based on the target evaluation metric, to be described further below.

As other examples of potential services provided by a platform implementing the environment 1100, the server computing device 1102 can maintain a variety of forecasting models in accordance with different information or requests. For example, the server computing device 1102 can maintain different families for deploying neural networks on the various types of TPUs and/or GPUs housed in the datacenter 432 or otherwise available for processing.

The devices 1102, 1104 and the datacenter 432 can be capable of direct and indirect communication over the network 1108. For example, using a network socket, the client computing device 1104 can connect to a service operating in the datacenter 432 through an Internet protocol. The devices 1102, 1104 can set up listening sockets that may accept an initiating connection for sending and receiving information. The network 1108 itself can include various configurations and protocols including the Internet, World Wide Web, intranets, virtual private networks, wide area networks, local networks, and private networks using communication protocols proprietary to one or more companies. The network 1108 can support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 1108, in addition or alternatively, can also support wired connections between the devices 1102, 1104 and the datacenter 1132, including over various types of Ethernet connection.

Although a single server computing device 1102, client computing device 1104, and datacenter 1132 are shown in FIG. 11, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing neural networks, and any combination thereof.

Unless otherwise stated, the examples described herein are not mutually exclusive, but may be implemented in various combinations to achieve unique advantages. As these and other variations and combinations of the features discussed above can be utilized without departing from the subject matter defined by the claims, the description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method, comprising:
receiving original input data;
training an encoder-decoder model using the original input data, the encoder-decoder model comprising an encoder and a decoder;
encoding the original input data into latent representations; and
training a generative adversarial network (GAN) framework, including a generator and a discriminator, based on the latent representations.

2. The method of claim 1, further comprising
generating synthetic data using the trained generator and the trained decoder.

3. The method of claim 2, wherein generating the synthetic data comprises:
sampling, by the generator, random vectors;
generating, by the generator, synthetic embeddings from the random vectors; and
using, by the decoder, the synthetic embeddings to generate synthetic temporal and categorical data.

4. The method of claim 1, wherein the original input data comprises one or more of static numeric features, static categorical features, temporal numeric features, temporal categorical features, or measurement time.

5. The method of claim 1, further comprising generating missing patterns representing missing features of the original input data.

6. The method of claim 5, further comprising generating original encoder states using the trained encoder, original input data, and the missing patterns.

7. The method of claim 1, wherein training the encoder-decoder model further comprises stochastic normalization for numerical features.

8. The method of claim 1, wherein training the encoder-decoder model comprises:
transforming categorical data into one-hot encoded data;
training a temporal categorical encoder and a temporal categorical decoder; and
transforming the one-hot encoded data into categorical embeddings.

9. The method of claim 1, wherein the original input data comprises heterogenous time-series data.

10. The method of claim 1, wherein the encoder-decoder model is trained using reconstruction loss, and the GAN framework is trained using adversarial loss

11. The method of claim 10, wherein reconstruction loss uses mean square error for temporal features, measurement time, and static features.

12. A system for generating synthetic data, comprising:
an encoder-decoder model comprising an encoder and a decoder; and
a generative adversarial network (GAN), comprising a generator and a discriminator, wherein the GAN is trained using latent representations from a training of the encoder-decoder model; and
wherein in generating the synthetic data, the generator is configured to receive random sample vectors and generate synthetic representations, and the decoder is configured to decode the synthetic representations.

13. The system of claim 12, wherein in decoding the synthetic representations, the decoder is configured to use the synthetic representations to generate synthetic temporal and categorical data.

14. The system of claim 12, wherein the encoder-decoder model is trained using original input data, the training including encoding the original input data into the latent representations that are provided to the GAN.

15. The system of claim 14, wherein training the encoder-decoder model comprises generating missing patterns representing missing features of the original input data.

16. The system of claim 15, wherein training the GAN framework comprises generating original encoder states using the trained encoder, original input data, and the missing patterns.

17. The system of claim 14, wherein the training of the encoder-decoder model comprises:
transforming categorical data into one-hot encoded data;
training a temporal categorical encoder and a temporal categorical decoder; and
transforming the one-hot encoded data into categorical embeddings.

18. The system of claim 14, wherein the original input data comprises heterogenous time-series data.

19. The system of claim 12, wherein the encoder-decoder model is trained using reconstruction loss, and the GAN framework is trained using adversarial loss

20. A non-transitory computer-readable medium storing instructions executable by one or more processors to perform a method comprising:
receiving original input data;
training an encoder-decoder model using the original input data, the encoder-decoder model comprising an encoder and a decoder, the training including encoding the original input data into latent representations; and
training a generative adversarial network (GAN) framework, including a generator and a discriminator, based on the latent representations.
